(19) United States
(12) Patent Application Publication
(10) Pub. No.: US 2023/0312032 A1
(43) Pub. Date: Oct. 5, 2023

(54) SADDLED VEHICLE

(71) Applicant: Honda Motor Co., Ltd., Tokyo (JP)

(72) Inventor: Shimpei SHIKANAI, Tokyo (JP)

(73) Assignee: Honda Motor Co., Ltd., Tokyo (JP)

(21) Appl. No.: 18/126,720

(22) Filed: Mar. 27, 2023

(30) Foreign Application Priority Data
Mar. 30, 2022 (JP) 2022-056773

(51) Int. Cl. B62H 1/02; B62K 25/04

(52) U.S. Cl. CPC B62H 1/02; B62K 25/04

(57) ABSTRACT

To provide a saddled vehicle whose center stand is set up with ease in a simplified structure. A saddled vehicle includes: a center stand that retains a vehicle body upright with a rear wheel lifted off a ground surface; a swingarm that pivotally holds the rear wheel and is swingably held on the vehicle body by a swingarm pivot; a rear suspension that suspends the swingarm from the vehicle body, the rear suspension having its expansion-side damping force varied by drive of an actuator; and a controller that controls the actuator. The controller minimizes the expansion-side damping force of the rear suspension according to an operation on an actuation switch.

### BACKGROUND

### 1. Technical Field

The present invention relates to a saddled vehicle. Specifically, the present invention relates to a saddled vehicle that includes a center stand that retains a vehicle body upright with a rear wheel lifted off the ground surface.

### 2. Description of the Background

Conventionally, there are known saddled vehicles that include a center stand that retains the vehicle body upright with a rear wheel lifted off the ground surface. In setting up the center stand, the rider lets the center stand touch the ground surface and then must exert great force to lift the rear of the vehicle body. Thus, setting up the center stand can be difficult with vehicles with large weights.

Patent Literature 1 discloses a motorcycle that includes a swingarm swingably held on a vehicle body to hold a rear wheel. In Patent Literature 1, an actuator increases the droop angle of the swingarm to raise the vehicle height so that the rider can easily set up a center stand.

### CITATION LIST

### Patent Literature

Patent Literature 1: DE 102018126233 A1

### BRIEF SUMMARY

The technique disclosed in Patent Literature 1 requires a dedicated actuator for changing the droop angle of the swingarm, which disadvantageously increases the number of components and weight.

An object of the present invention is to solve the problem, and to provide a saddled vehicle whose center stand is set up with ease in a simplified structure.

In order to achieve the object, a first aspect of the present invention provides a saddled vehicle (1) including: a center stand (11) that retains a vehicle body upright with a rear wheel (WR) lifted off a ground surface (G); a swingarm (12) that pivotally holds the rear wheel (WR) and is swingably held on the vehicle body by a swingarm pivot (9); a rear suspension (14) that suspends the swingarm (12) from the vehicle body, the rear suspension (14) having its expansion-side damping force varied by drive of an actuator (30); and a controller (22) that controls the actuator (30). The controller (22) minimizes the expansion-side damping force of the rear suspension (14) according to an operation on an actuation switch (20).

A second aspect further includes a center stand angle sensor (23) that detects an unfolding state of the center stand (11). The controller (22) lets the rear suspension (14) recover its original expansion-side damping force when the controller (22) detects that the center stand (11) has been unfolded to a fully unfolded position.

In a third aspect, the controller (22) makes an output signal of the actuation switch (20) valid only when an ignition signal (21) of the saddled vehicle (1) is off.

A fourth aspect of the present invention provides a saddled vehicle (1) including: a center stand (11) that retains a vehicle body upright with a rear wheel (WR) lifted off a ground surface (G); a swingarm (12) that pivotally holds the rear wheel (WR) and is swingably held on the vehicle body by a swingarm pivot (9); a rear suspension (14) that suspends the swingarm (12) from the vehicle body, the rear suspension (14) having its expansion-side damping force varied by drive of an actuator (30); a controller (22) that controls the actuator (30); and a center stand angle sensor (23) that detects an unfolding state of the center stand (11). The controller (22) minimizes the expansion-side damping force of the rear suspension (14) when the controller (22) detects that the center stand (11) has been unfolded by a predetermined angle at which the center stand (11) touches a ground surface (G).

In a fifth aspect, the controller (22) lets the rear suspension (14) recover its original expansion-side damping force when the controller (22) detects that the center stand (11) has expanded to the fully unfolded position.

The first aspect provides a saddled vehicle (1) including: a center stand (11) that retains a vehicle body upright with a rear wheel (WR) lifted off a ground surface (G); a swingarm (12) that pivotally holds the rear wheel (WR) and is swingably held on the vehicle body by a swingarm pivot (9); a rear suspension (14) that suspends the swingarm (12) from the vehicle body, the rear suspension (14) having its expansion-side damping force varied by drive of an actuator (30); and a controller (22) that controls the actuator (30). The controller (22) minimizes the expansion-side damping force of the rear suspension (14) according to an operation on an actuation switch (20). Generally, in setting up the center stand, the rider lets the center stand touch the ground surface and then must exert great force to lift the rear of the vehicle body. In the present aspect, the expansion-side damping force of the rear suspension is minimized according to an operation on an actuation switch, facilitating expansion of the rear suspension. Thus, the rider can easily lift the rear of the vehicle body using momentum. Hence, the center stand can be set up with ease.

The second aspect further includes a center stand angle sensor (23) that detects an unfolding state of the center stand (11). The controller (22) lets the rear suspension (14) recover its original expansion-side damping force when the controller (22) detects that the center stand (11) has been unfolded to a fully unfolded position. This prevents the expansion-side damping force from recovering its original state when the center stand is insufficiently unfolded, and ensures completing the setting up the center stand.

In the third aspect, the controller (22) makes an output signal of the actuation switch (20) valid only when an ignition signal (21) of the saddled vehicle (1) is off. Thus, for example, the expansion-side damping force will not vary even if the rider accidentally operates the rear suspension actuation switch during riding. This gives the rider the higher sense of security.

The fourth aspect provides a saddled vehicle (1) including: a center stand (11) that retains a vehicle body upright with a rear wheel (WR) lifted off a ground surface (G); a swingarm (12) that pivotally holds the rear wheel (WR) and is swingably held on the vehicle body by a swingarm pivot (9); a rear suspension (14) that suspends the swingarm (12) from the vehicle body, the rear suspension (14) having its expansion-side damping force varied by drive of an actuator (30); a controller (22) that controls the actuator (30); and a center stand angle sensor (23) that detects an unfolding state of the center stand (11). The controller (22) minimizes the expansion-side damping force of the rear suspension (14) when the controller (22) detects that the center stand (11) has been unfolded by a predetermined angle at which the center stand (11) touches a ground surface (G). The expansion-side damping force of the rear suspension is minimized as the center stand is set up. This eliminates the necessity of operating an actuation switch, and the center stand is set up with ease.

In the fifth aspect, the controller (22) lets the rear suspension (14) recover its original expansion-side damping force when the controller (22) detects that the center stand (11) has expanded to the fully unfolded position. Thus, without the necessity of operating an actuation switch, the setting up the center stand is completed.

### BRIEF DESCRIPTION OF DRAWINGS

FIG. 1 is a left-side view of a motorcycle according to the present embodiment.

FIG. 2 is a block diagram of a control system of rear suspensions.

FIG. 3 is a left-side view of the motorcycle with its center stand beginning to be unfolded having its ground part put on the ground surface.

FIG. 4 is a left-side view of the motorcycle having its center stand further unfolded from the state in FIG. 3.

FIG. 5 is a left-side view of the motorcycle with its center stand fully unfolded to a fully unfolded position to complete setting up the center stand.

FIG. 6 is a flowchart of the procedure of center stand set-up control 1.

FIG. 7 is a block diagram of a control system of the rear suspensions according to a variation of the present embodiment.

FIG. 8 is a flowchart of the procedure of center stand set-up control 2.

FIG. 9 is a perspective view of a rear suspension.

FIG. 10 is a schematic illustration of the structure of a rear suspension according to a variation of the present invention.

### DETAILED DESCRIPTION

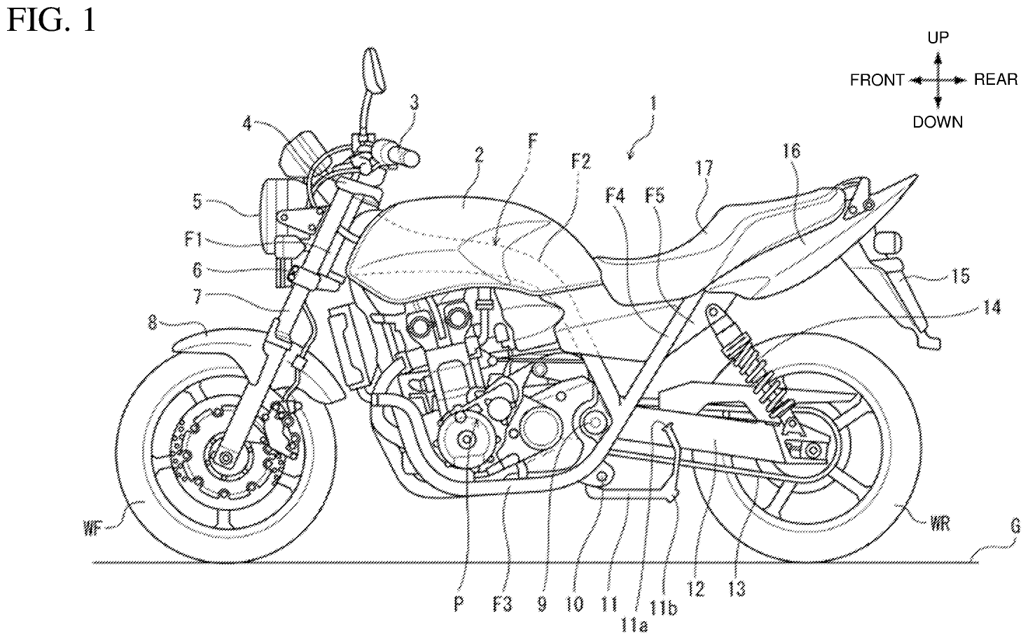

In the following, with reference to the drawings, a detailed description will be given of preferred embodiments of the present invention. FIG. 1 is a left-side view of a motorcycle 1 according to the present embodiment. The motorcycle 1 is a saddled vehicle that travels by transmitting the drive of a power unit P to a rear wheel WR via a drive chain 13. At the front end of a main frame F2 forming a vehicle frame F, a head pipe F1 that rotatably supports a steering stem (not shown) is provided.

A top bridge 4 is fixed to the upper part of the steering stem. A bottom bridge 6 is fixed to the lower part of the steering stem. A steering handlebar 3 for steering a front wheel WF is fixed to the upper part of the top bridge 4. The front wheel WF is rotatably held by the lower end of a pair of right and left front forks 7 that are held by the top bridge 4 and the bottom bridge 6. A front fender 8 is mounted on the front forks 7 to cover the front wheel WF from above.

A power unit P, made up of integrated engine and transmission, is disposed between the main frame F2 extending rearward from the head pipe F1 and under frames F3 extending steeply downward toward the rear from the head pipe F1. The right and left pair of under frames F3 extend rearward below the power unit P, then extend upward toward the rear to be coupled to a pair of right and left rear frames F4. The rear frames F4 are provided with rear suspension holders F5 for holding the upper ends of a right and left pair of rear suspensions 14.

A swingarm pivot 9 swingably holding a swingarm 12 is provided at the rear end of the main frame F2 where it joins the under frames F3. The rear part of the swingarm 12 that rotatably holds the rear wheel WR is suspended from the rear suspension holders F5 by the rear suspensions 14.

A fuel tank 2 shaped to straddle the main frame F2 is disposed on the main frame F2. A seat 17 is disposed behind the fuel tank 2. A rear fender 15 covering the rear wheel WR from above is mounted on a pair of right and left rear cowls 16 that cover the seat 17 from below.

A swing shaft 10 that swingably holds a center stand 11 is provided under the swingarm pivot 9 and at the rear bottom ends of the under frames F3. The center stand 11, which is for retaining the vehicle body upright with the rear wheel WR lifted off the ground surface G in parking, includes a step part 11a that the rider steps on in unfolding the center stand 11 and a ground part 11b that stands on the ground surface G. The center stand 11 is unfolded from a retracted position to a fully unfolded position and is biased toward the retracting direction by a return spring.

The rear suspensions 14 have their expansion-side damping force adjusted by the drive of an actuator. The motorcycle 1 according to the present embodiment is characterized in that the expansion-side damping force of the rear suspensions 14 is varied to facilitate setting up the center stand 11. The expansion-side damping force is adjusted by, for example, varying the cross-sectional area of an oil passage provided at a hydraulic piston that slides inside each rear suspension 14 or the cross-sectional area of an oil passage for hydraulic oil. The actuator may be a motor or a hydraulic pump.

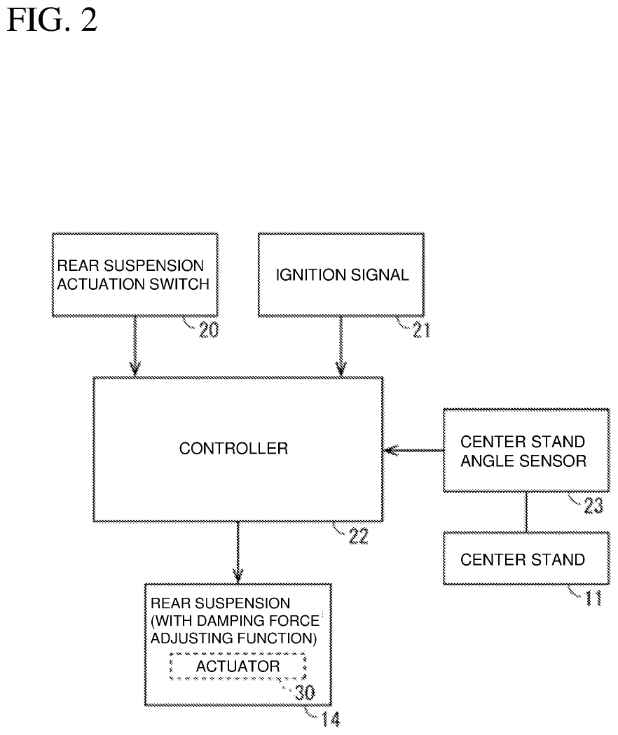

FIG. 2 is a block diagram of a control system of the rear suspensions 14. A controller 22 receives output signals from a rear suspension actuation switch 20, ignition signals 21 indicative of the driving state of the engine of the motorcycle 1, and output signals from a center stand angle sensor 23 that detects the unfolding angle of the center stand 11. The rear suspension actuation switch 20 is a switch that the rider operates at any timing in setting up the center stand 11. The controller 22 drives the actuator 30 of each of the rear suspensions 14 according to the output signals to vary the expansion-side damping force of the rear suspensions 14. The rear suspension actuation switch 20 may be disposed at the steering handlebar 2 or the rear suspension holder F5, for example.

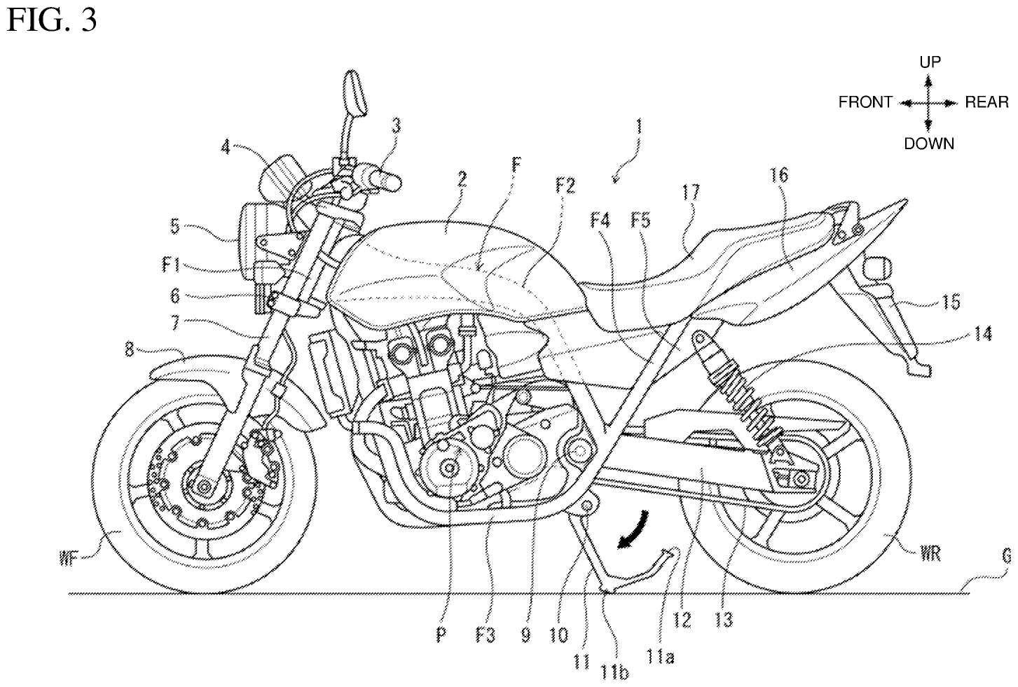

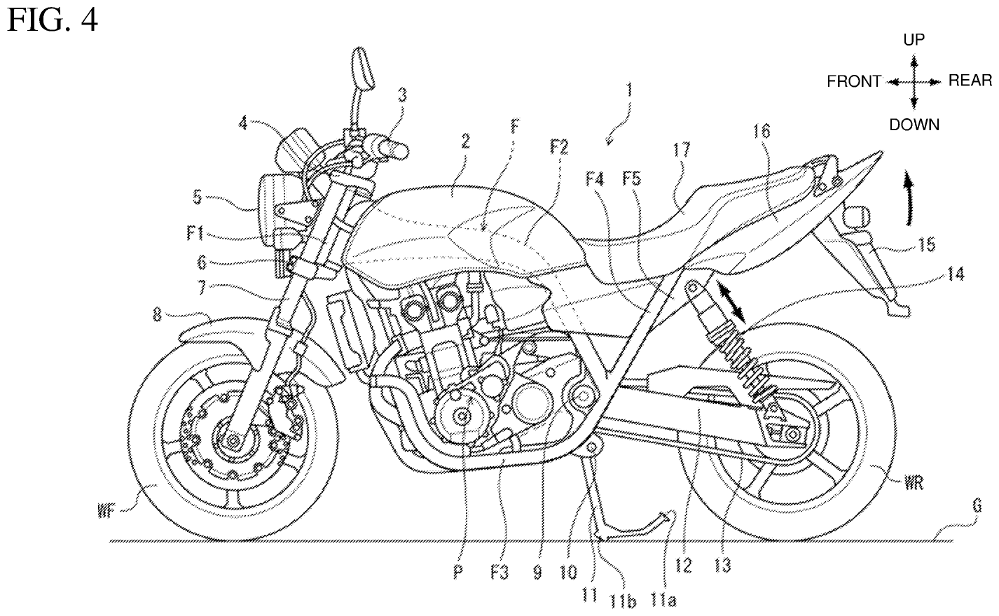

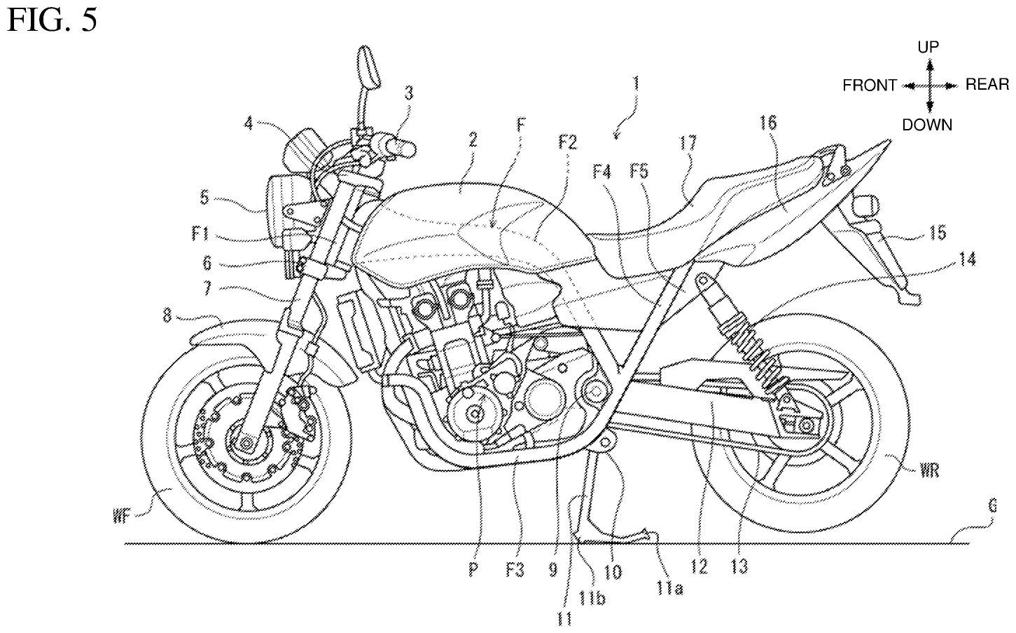

FIG. 3 is a left-side view of the motorcycle 1 with its center stand 11 beginning to be unfolded having its ground part 11b put on the ground surface G. FIG. 4 is a left-side view of the motorcycle 1 with its center stand 11 further unfolded from the state in FIG. 3. FIG. 5 is a left-side view of the motorcycle 1 with its center stand 11 fully unfolded to the fully unfolded position to complete setting up the center stand.

Generally, in setting up the center stand 11, the rider lets the center stand 11 touch the ground surface G and then must exert great force to lift the rear of the vehicle body. Here, in the present embodiment, the rider operates the rear suspension actuation switch 20 when the ignition signals 21 are off while parking, to minimize the expansion-side damping force of the rear suspensions 14. This facilitates expansion of the rear suspensions 14, and the rider can easily lift the rear of the vehicle body using momentum.

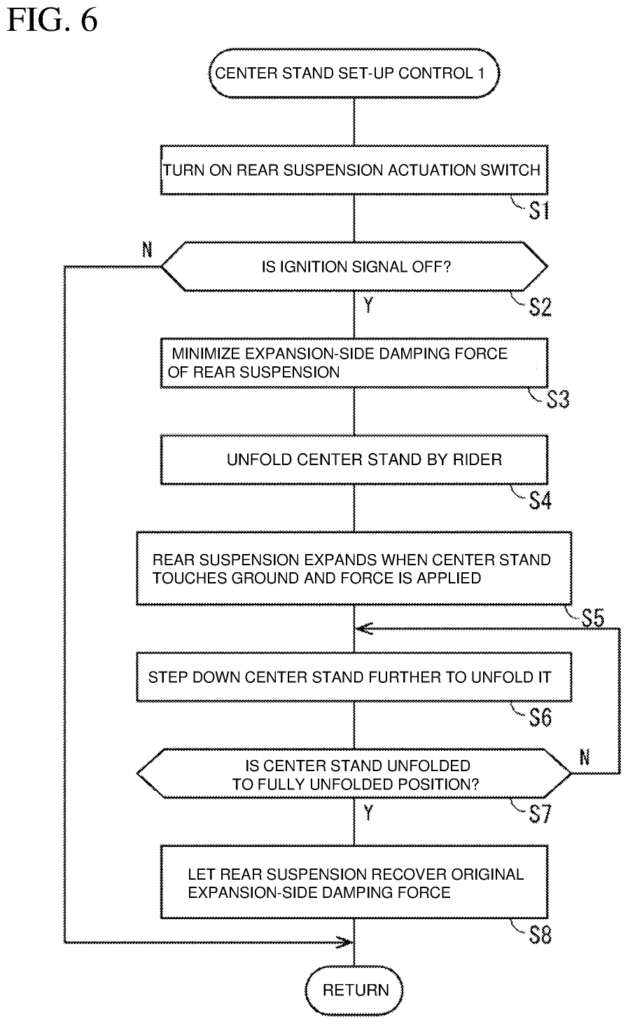

FIG. 6 is a flowchart of the procedure of center stand set-up control 1. In step S1, the rear suspension actuation switch 20 is turned on. In step S2, whether the ignition signal 21 is off is determined. When a positive determination is made in step S2, control proceeds to step S3 and minimizes the expansion-side damping force of the rear suspension 14.

On the other hand, when a negative determination is made in step S2, the series of control ends. That is, the controller 22 makes the output signal from the rear suspension actuation switch 20 valid only when the ignition signal 21 is being turned off. Thus, for example, the expansion-side damping force will not vary even if the rider accidentally operates the rear suspension actuation switch 20 during riding. This gives the rider the higher sense of security.

In the following step S4, the rider starts unfolding the center stand 11. In step S5, when the center stand 11 touches the ground and the rider applies force, the rear suspensions 14 expand. In step S6, the rider further steps down the step part 11a of the center stand 11 to unfold it to the fully unfolded position. In step S7, whether the center stand 11 is unfolded to the fully unfolded position is determined according to the output signal from the center stand angle sensor 23. When a positive determination is made, control proceeds to step S8. In step S8, control lets the rear suspensions 14 recover their original expansion-side damping force, and the series of control ends.

Note that, when a negative determination is made in step S7, control returns to step S6. That is, the controller 22 detects that the center stand 11 is unfolded to the fully unfolded position and allows the rear suspensions 14 to recover their original expansion-side damping force. This prevents the expansion-side damping force from recovering its original state when the center stand 11 is insufficiently unfolded, and ensures completing the setting up the center stand.

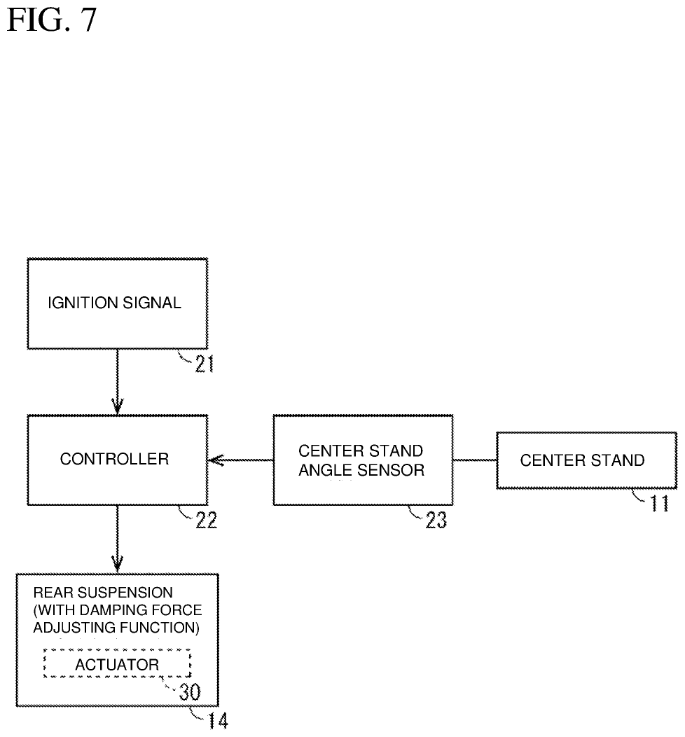

FIG. 7 is a block diagram of a control system of the rear suspensions 14 according to a variation of the present embodiment. The variation is different from the configuration in FIG. 2 in not including the rear suspension actuation switch 20. In the variation, the expansion-side damping force of the rear suspensions 14 is minimized by being triggered by the center stand 11 unfolded to the predetermined angle.

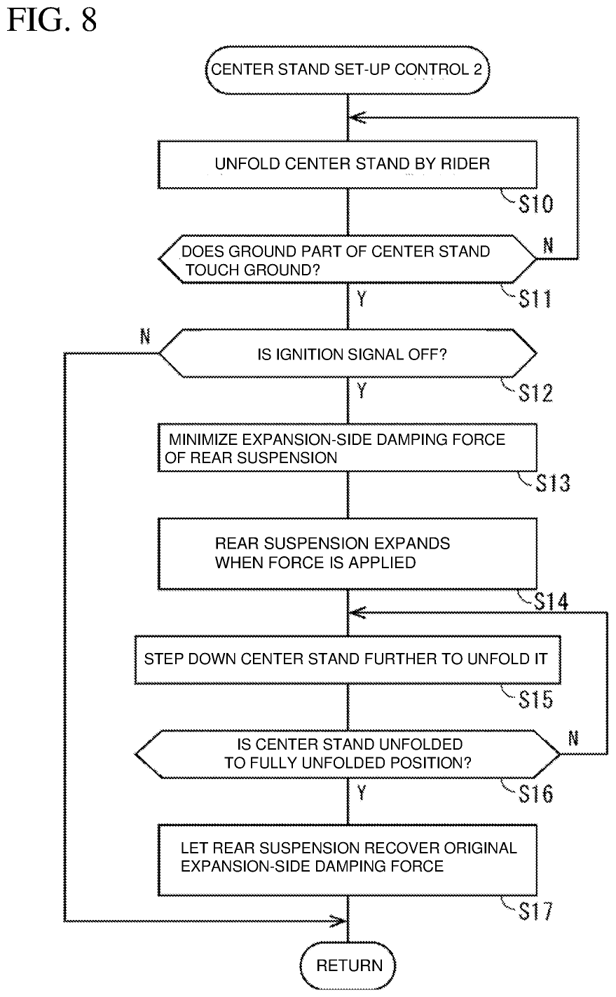

FIG. 8 is a flowchart of the procedure of center stand set-up control 2. In step S10, the rider starts unfolding the center stand 11. In step S11, whether the center stand 11 is unfolded to the angle at which the ground part 11a of the center stand 11 touches the ground is determined according to the output signal from the center stand angle sensor 23.

In step S12, whether the ignition signal 21 is off is determined. When a positive determination is made in step S12, control proceeds to step S13 and minimizes the expansion-side damping force of the rear suspensions 14. On the other hand, when a negative determination is made in step S12, the series of control ends.

In the following step S14, when the center stand 11 touches the ground and the rider applies force, the rear suspensions 14 expand. In step S15, the rider further steps down the step part 11a of the center stand 11 to unfold it to the fully unfolded position. In step S16, whether the center stand 11 is unfolded to the fully unfolded position is determined according to the output signal from the center stand angle sensor 23. When a positive determination is made, control proceeds to step S17. In step S17, control lets the rear suspensions 14 recover their original expansion-side damping force, and the series of control ends. Note that, when a negative determination is made in step S16, control returns to step S15.

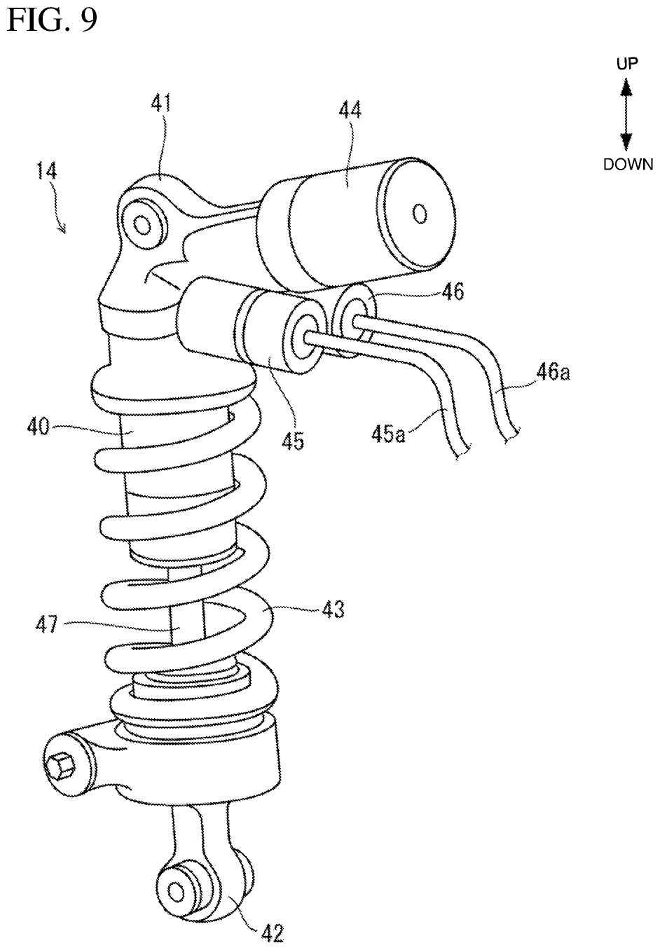

FIG. 9 is a perspective view of one of the rear suspensions 14. Various changes may be made with the structure of the rear suspensions capable of adjusting the damping force. An upper holder 41 to be held on the rear suspension holder F5 is formed on a damper body 40 of the rear suspension 14. A cushion rod 47 slidably inserted into the lower part of the damper body 40 is fixed to a lower holder 42 held on the swingarm 12. Near the upper holder 41, a reservoir tank 44 that stores hydraulic oil that enters or exits the damper body 40 according to the sliding operation of the cushion rod 47 is disposed. Below the reservoir tank 44, an actuator 45 that adjusts the expansion-side damping force and an actuator 46 that adjusts the compression-side damping force are disposed. The actuators 45, 46 are stepping motors and adjust the damping force of the rear suspension 14 according to electric signals received from the harnesses 45a, 46a.

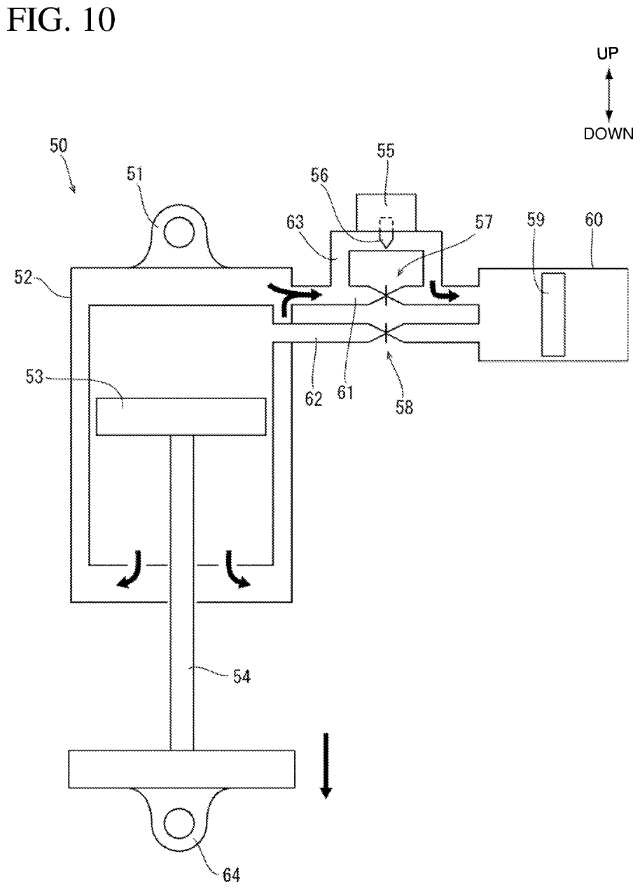

FIG. 10 is a schematic illustration of the structure of a rear suspension 50 according to a variation of the present invention. In the rear suspension 50, a linear solenoid 55 as an actuator opens a bypass passage 63 to minimize the expansion-side damping force. An upper holder 51 to be held on the rear suspension holder F5 is formed on a damper body 52 of the rear suspension 50. A cushion rod 54 that is slidably inserted into the lower part of the damper body 52 and holds a piston 53 is fixed to a lower holder 64 held on the swingarm 12. Near the upper holder 51, a reservoir tank 60 that stores hydraulic oil that enters or exits the damper body 52 by the sliding operation of the cushion rod 54 is disposed. The reservoir tank 60 houses a free piston 59 that separates the hydraulic oil and a gas chamber. The damper body 52 and the reservoir tank 60 are connected to each other via an inbound passage 61 and an outbound passage 62. An expansion-side damping force adjusting mechanism 57 is provided at the inbound passage 61. A compression-side damping force adjusting mechanism 58 is provided at the outbound passage 62. In the variation, the inbound passage 61 includes a bypass passage 63 that bypasses the expansion-side damping force adjusting mechanism 57. The bypass passage 63 is opened or closed by a valve 56 projecting or retracting by the operation of the linear solenoid 55. In this structure, by the linear solenoid 55 being turned off to retract the valve 56, the bypass passage 63 is opened to minimize the expansion-side damping force.

As has been described above, the saddled vehicle of the present invention includes the rear suspensions whose expansion-side damping force can be minimized by the drive of the actuator. This facilitates expansion of the rear suspensions in setting up the center stand. Thus, the operation of setting up the center stand is done with ease, i.e., the vehicle exhibits improved convenience.

Note that, the mode of the motorcycle, the shape or arrangement of the center stand, the structure of the rear suspensions, the structure for adjusting the expansion-side damping force of the rear suspensions, the mode of the actuator, and the configuration of the control system of the rear suspensions are not specified to those of the embodiment, and various changes can be made. For example, in addition to the control in which the actuator minimizes the expansion-side damping force, the effect of a preload adjuster may be minimized. The expansion structure of the rear suspensions of the present invention is not limited to a motorcycle including two rear suspensions, and is applicable to a motorcycle in which one rear suspension supports a swingarm, or a tricycle including two front wheels.

### REFERENCE SIGNS LIST

1: motorcycle (saddled vehicle)
9: swingarm pivot
11: center stand
12: swingarm
14, 50: rear suspension
20: actuation switch
22: controller
23: center stand angle sensor
30: actuator
WR: rear wheel
G: ground surface

What is claimed is:

1. A saddled vehicle comprising:
a center stand that retains a vehicle body upright with a rear wheel lifted off a ground surface;
a swingarm that pivotally holds the rear wheel and is swingably held on the vehicle body by a swingarm pivot;
a rear suspension that suspends the swingarm from the vehicle body, the rear suspension having its expansion-side damping force varied by drive of an actuator; and
a controller that controls the actuator, wherein
the controller minimizes the expansion-side damping force of the rear suspension according to an operation on an actuation switch.

2. The saddled vehicle according to claim 1, further comprising a center stand angle sensor that detects an unfolding state of the center stand, wherein the controller lets the rear suspension recover its original expansion-side damping force when the controller detects that the center stand has been unfolded to a fully unfolded position.

3. The saddled vehicle according to claim 1, wherein the controller makes an output signal of the actuation switch valid only when an ignition signal of the saddled vehicle is off.

4. The saddled vehicle according to claim 2, wherein the controller makes an output signal of the actuation switch valid only when an ignition signal of the saddled vehicle is off.

5. A saddled vehicle comprising:
a center stand that retains a vehicle body upright with a rear wheel lifted off a ground surface;
a swingarm that pivotally holds the rear wheel and is swingably held on the vehicle body by a swingarm pivot;
a rear suspension that suspends the swingarm from the vehicle body, the rear suspension having its expansion-side damping force varied by drive of an actuator;
a controller that controls the actuator; and
a center stand angle sensor that detects an unfolding state of the center stand, wherein
the controller minimizes the expansion-side damping force of the rear suspension when the controller detects that the center stand has been unfolded by a predetermined angle at which the center stand touches a ground surface.

6. The saddled vehicle according to claim 5, wherein the controller lets the rear suspension recover its original expansion-side damping force when the controller detects that the center stand has expanded to the fully unfolded position.
